(19) United States
(12) Patent Application Publication
(10) Pub. No.: US 2009/0120607 A1
(43) Pub. Date: May 14, 2009

(54) COOLER FOR SPATIALLY CONFINED COOLING

(76) Inventors: Peter CHEON, Auburn, WA (US); AnKuk SONG, AnYang-Shi (KR); JeaSung PARK, Gunpo-shi (KR); Eungsoon LEE, AnYang-Shi (KR); Tim HUNTING, Auburn, WA (US)

Correspondence Address: DWC LAW FIRM, P.S., P.O. BOX 3041, SEATTLE, WA, 98114-3041, US

(21) Appl. No.: 11/937,486

(22) Filed: Nov. 8, 2007

(51) Int. Cl. F28F 7/00; F28D 15/00; H02B 1/56

(52) U.S. Cl. 165/46; 165/104.33; 361/669

(57) ABSTRACT

A plurality of cooling units for cooling electrical components can be disposed in close proximity to one another in confined spaces with minimal space conflict, due to the design of the cooling units that allows for staggered position of connection fittings. Also, the cooling units can be selectively arranged in a plurality of configurations with respect to one another, while being fluidly connected.

### BACKGROUND

1. Field of the Invention

The present invention relates to coolers, and more particularly, to cooling jacket units and assemblies that are spatially efficient for cooling one or more small electrical components.

2. Description of Related Art

In general, in order to cool various heat-generating elements such as semiconductor chips or electronic devices in a liquid cooling manner, a surface contacting a heat-generating element has been made of metal and cooling blocks in which a coolant circulates have been used. Since the conventional cooling blocks are formed of hard materials such as metal in consideration of heat conductivity, it is difficult to make them contact various types of surfaces, e.g., uneven surfaces. Also, due to limitation in installation space, the cooling blocks are difficult to directly install on the various electronic devices such as hard disk drives, video cards or memory cards and a PCB. In order to increase close adhesion, various adhesive devices having an elaborately fabricated contact surface and a strong clipping force have been used. However, such adhesive devices are mechanically complex.

In U.S. Pat. No. 7,167,366, a liquid cooling type, soft cooling jacket for an electronic device is disclosed. The soft cooling jacket is adapted to various shapes of heat-generating elements having uneven surfaces and various shapes of installation spaces beyond electrical and mechanical limitation to increase a heat transfer area and maximize heat transfer efficiency and can be installed at various electronic devices such as hard disk drives, video cards or memory cards and a PCB.

The soft cooling jack disclosed in U.S. Pat. No. 7,167,366 can include a pouch body formed of a soft, loose elastic material that is deformable to closely contact heat-generating elements having various shapes due to a contact pressure and accommodating a coolant that is able to circulate inside the pouch body and be connected to coolant circulation lines for circulating the coolant. However, it has been observed by the inventor(s) hereof, that the casing and connection devices for the pouch body for the soft cooling jacket can be obstructive when space confines are encountered. For example, on slot connectors for PCBs, the space between PCBs can become small as more PCBs are connected to the slot connector. The cooling jacket then needs to be attached to the PCBs in spaced-apart fashion, skipping slots on the slot connector. As such, efficient utilization of space on the slot connector is impaired, limiting the number of PCBs that can be connected to both the soft cooling jacket and slot connector simultaneously.

### BRIEF SUMMARY

Some embodiments of the present invention involve a cooling jacket assembly comprising a plurality of cooling jacket units with each cooling jacket unit having at least one inlet connection nozzle, at least one outlet connection nozzle, at least one deformable pouch connected to the connection nozzles, and a case enclosing the deformable pouch. The plurality of cooling jacket units can be fluidly connected to one another by removable conduits, with each case of each cooling jacket unit being adjacent to at least one case of another cooling jacket unit, and wherein the connection nozzles of each cooling jacket unit are disposed in staggered relation with respect to each adjacent cooling jacket unit, to avoid space conflict between the connection nozzles and the associated fittings of the connection nozzles.

In some embodiments, the deformable pouch for each cooling unit is connected to an inlet connection nozzle and an outlet connection nozzle, with a space between the inlet connection nozzle and the outlet connection nozzle being off-centered with respect to a longitudinal axis of the deformable pouch. Also, or alternatively, a casing for the deformable pouch can have an opening through which the inlet connection nozzle can extend and an opening through which the outlet connection nozzle extend, and a space between the openings can be off-centered with respect to a longitudinal axis of the casing. In some embodiments of the present invention, the off-centered position of the space between the connection nozzles, or between openings on the casing, can allow the cooling jacket units to be positioned adjacent other cooling jacket units without resulting in conflicting space requirements for fittings associated with the connection nozzles.

### BRIEF DESCRIPTION OF SEVERAL VIEWS OF THE DRAWINGS

FIG. 1 is a perspective view of an embodiment of a cooling jacket unit of the present invention, with deformable pouches usable for contact cooling, being encased within a case therefor.

FIG. 2 is an exploded view of the embodiment of the cooling jacket unit of FIG. 1.

FIG. 3 is an overhead sectional view of the cooling jacket unit of FIG. 1, with the cooling jacket unit being connected to a cooling liquid inlet chamber and cooling liquid outlet chamber, and with the direction of coolant flow being represented by an elongated arrow.

FIG. 4 is a side elevation cross-sectional view of the cooling jacket unit of FIG. 1 showing the direction of liquid coolant flow within the cooling jacket unit, entering from an inlet in the left side top connection nozzle, flowing through a deformable pouch, and then exiting from an outlet in the right side top connection nozzle.

FIG. 5a is an overhead sectional view of an embodiment of a cooling jacket assembly of the present invention, comprising a plurality of cooling jacket units of FIG. 1, assembled in a first connected form with staggered configuration.

FIG. 5b is an enlarged partial view of the cooling jacket assembly of FIG. 5a showing a left side of the cooling jacket assembly of FIG. 5a.

FIG. 6 is an overhead sectional view of an embodiment of a cooling jacket assembly of the present invention, comprising a plurality of cooling jacket units of FIG. 1, assembled in a second connected form with non-staggered configuration.

FIG. 7 is an overhead sectional view of an embodiment of a cooling jacket assembly of the present invention, comprising a plurality of cooling jacket units of FIG. 1, assembled in a third connected form with non-staggered configuration.

FIG. 8 is an overhead sectional view of an embodiment of a cooling jacket assembly of the present invention, comprising a plurality of cooling jacket units of FIG. 1, assembled in a fourth connected form with staggered configuration.

FIG. 9 is an overhead plan view of the embodiment of the cooling jacket assembly shown in FIG. 5a, except with two of the cooling jacket units disposed in spaced-apart relation.

FIG. 10 is a perspective view of an embodiment of the connection nozzle portions of two cooling jacket units disposed side-by-side and connected by a screw-type connector of the present invention, showing the screw-type connector being extended.

### DETAILED DESCRIPTION OF PREFERRED EMBODIMENTS OF THE INVENTION

In the following description, certain specific details are set forth in order to provide a thorough understanding of various embodiments of the invention. However, upon reviewing this disclosure, one skilled in the art will understand that the invention may be practiced without many of these details. In other instances, well-known structures related to cooling systems, heat generating electrical components, and materials of construction therefore have not been described in detail to avoid unnecessarily obscuring the descriptions of the embodiments of the invention.

U.S. Pat. No. 7,167,366 discloses a liquid cooling type, cooling jacket for an electronic device, and is hereby incorporated by reference in its entirety. The cooling jacket is adapted to various shapes of heat-generating elements having uneven surfaces and various shapes of installation spaces. The cooling jack can include a pouch body formed of a soft, loose elastic material that is deformable to closely contact heat-generating elements having various shapes due to a contact pressure and accommodating a coolant.

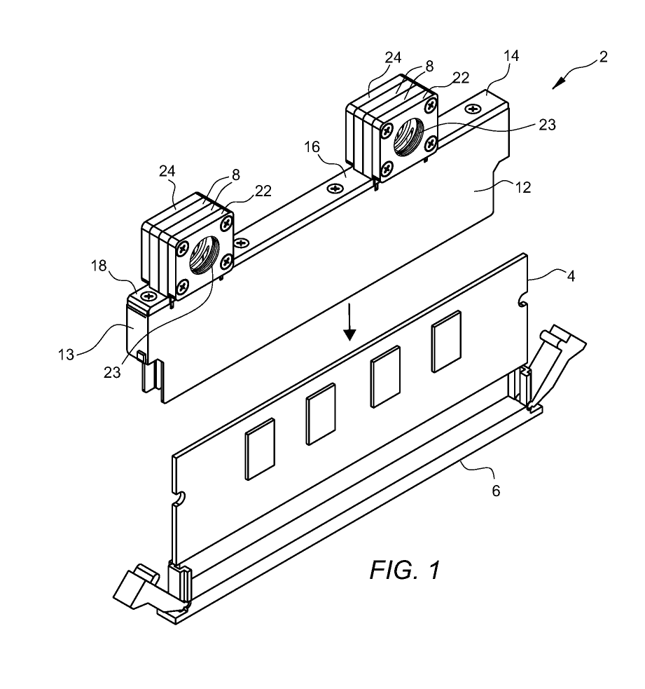

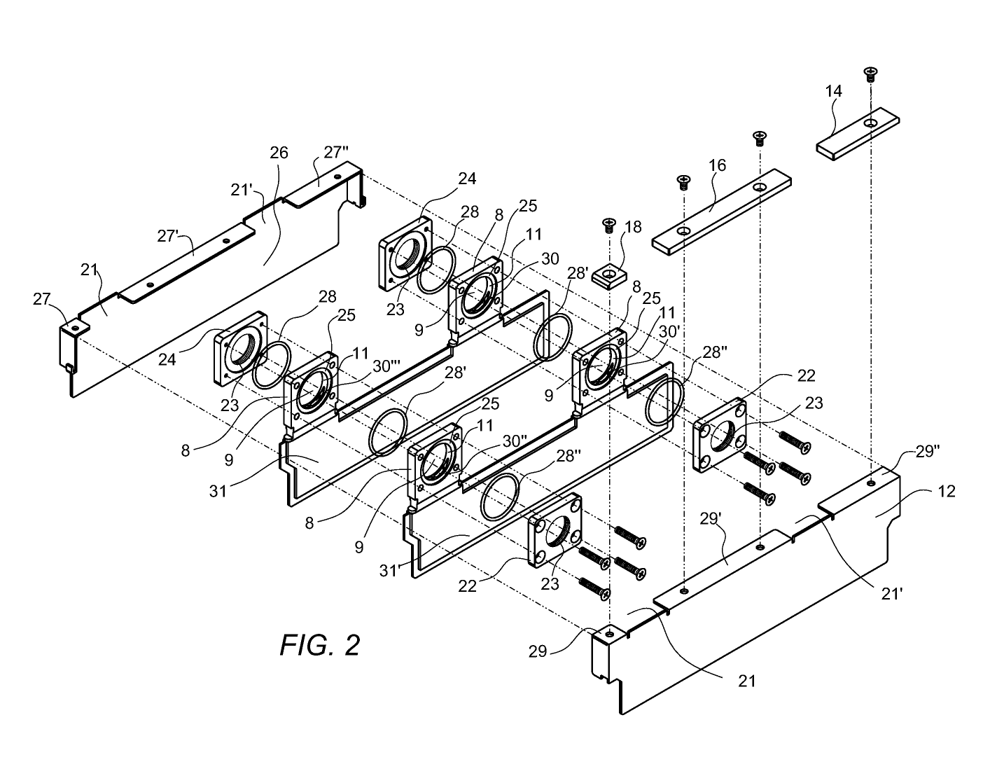

FIGS. 1 & 2, show a cooling jacket unit 2, having a case 13 with a first case section 12 and a second case section 26. The first case section 12 and second case section 26 can be connected to one another. Three overhead wall portions 29, 29′ and 29″ of the first case section 12 can be placed in overlapping alignment with three corresponding overhead wall portions 27, 27′ and 27″ of the second case section 26. Also, one of each of the connection plates 14, 16, and 18 can be individually aligned with, and placed over the top of, one the three overlapping overhead wall portions, as shown in FIG. 2. As such, when corresponding screw holes on the connection plates 14, 16, 18 and overhead wall portions are aligned, screws can be threaded through the screw holes to fixedly attach the first case section 12 to the second case section 26. It is noted that in the illustrated embodiment in FIGS. 1 & 2, overhead openings 21, 21′ are provided in the overhead wall portions of the case sections 12, 26.

When the first case section 12 and second case section 26 are fixed together, they can encase a plurality of cooling pouches 31, 31′. In the embodiment shown in FIG. 2, two (2) cooling pouches 31, 31′ are provided, with each cooling pouch 31, 31′ being connected to a pair of connection nozzles 8. The connection nozzles 8 each comprise a circular opening 9 having a passageway (the four (4) passageways, one for each of the four (4) connection nozzles 8 illustrated in FIG. 2, are labeled 30, 30′, 30″, and 30′″, respectively). Each passageway is formed on a side wall 11 of the corresponding circular opening 9. Each of the passageways is in communication with an internal chamber of a pouch 31, 31′ and can allow coolant to flow from the circular openings 9 of the connection nozzles 8 into, or out of, the pouches 31, 31′. That is, for example, on pouch 31, liquid coolant can flow into passageway 30, through the connected pouch 31, and exit from passageway 30′″ (as will be illustrated below in further detail), or vice versa. The pouch body is deformable to closely contact a heat generating surface, such as a PCB, to cool a heat generating surface.

The connection nozzles 8 of pouch 31, can be matably aligned in side-by-side fashion with corresponding connection nozzles 8 of the other pouch 31′, as illustrated in FIG. 1. Also, referring back to FIG. 2, a central o-ring seal 28′ can be disposed between each pair of mated connection nozzles 8. The two illustrated central o-ring seals 28′ can rest in annular gaps 25, provided in complimentary fashion on the face of each connection nozzle 8, as will be appreciated by those skilled in the art after reviewing this disclosure.

Referring to FIG. 1, when the connection nozzles 8 are mated together, the central o-ring seal 28′ between the connection nozzles 8 is not visible, as it is compressed within the gaps of the connection nozzles 8 to seal liquid from escaping from between the mating faces of the connection nozzles 8.

Separate threaded compression plates 22, 24, each having a threaded opening 23, can be coupled against an outer face of a connection nozzle 8, as shown in FIG. 1. Referring to FIG. 2, an exterior o-ring 28, 28″ can be disposed between each threaded compression plate 22, 24 and each outer face of each corresponding connection nozzle 8. The threaded compression plates 22, 24 can have threaded screw holes that are alignable with corresponding threaded screw holes on the corresponding connection nozzles 8, to allow the threaded compression plates 22, 24 to be affixed to the connection nozzles 8 using screws.

When the first case section 12 and second case section 26 are coupled together, a portion of the connection nozzles 8 can protrude through the overhead openings 21, 21′ of the case sections 12, 26. For each cooling jacket unit, the overhead openings 21, 21′, and thus the connection nozzles 8, can be positioned so that a space between the connection nozzles 8 is off-centered with respect to a longitudinal axis of the case 13. That is, for example, as best seen in FIG. 1, the space between the two connection nozzles 8 on the left side of the cooking jacket unit 2 and the two connection nozzles 8 on the right side of the cooling jacket unit, is shifted to the left, and the left side connection nozzles 8 are closer to the left end portion of the cooling jacket unit 2 than the right side connection nozzles 8 are to the right end portion of the cooling jacket unit.

When the entire cooling jacket unit 2 is assembled as shown in FIG. 1, the pouches 31 can hang downward from the connection nozzles 8, within the case 13. Still referring to FIG. 1, the cooling jacket unit 2 can be fitted over a PCB 4 (or other heat generating component or device), and pushed downward until the PCB 4 is disposed between the pouches 31, 31′ within the cooling jacket unit 2. The deformable pouches 30, 31 can conform to a surface of the PCB and maintain close contact therewith. Thereafter, coolant that is circulated through the pair of pouches 31, 31′ can cool the PCB 4 from two sides.

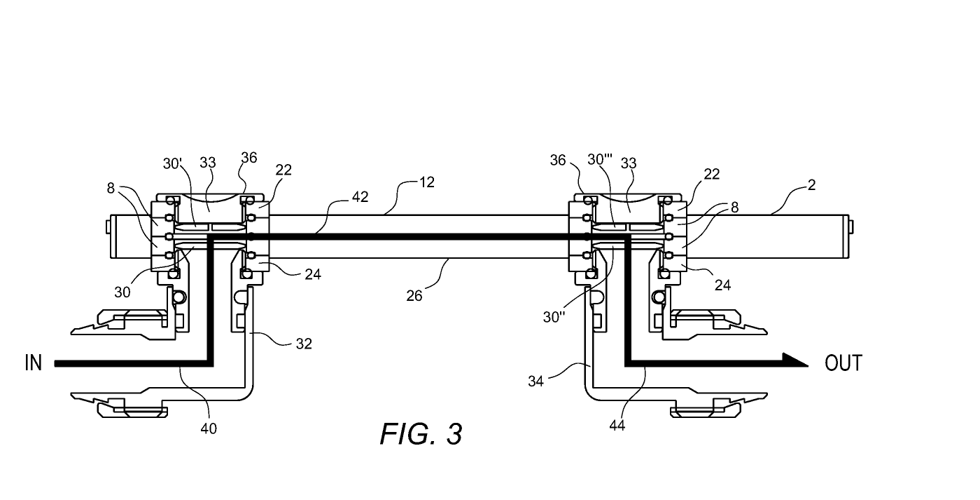

Now, referring to FIG. 3, an inlet chamber 32 can be threadedly connected (e.g., removably screw fitted) to one of the threaded compression plates 24 of a cooling jacket unit 2. An outlet chamber 34 can be threadedly connected to another threaded compression plate 24 located on a second connection nozzle 8 of the cooling jacket unit 2. The threaded openings 23 of the opposite threaded compression plates 22 can be sealed by threadedly connecting a plug fitting 33 to the threaded openings 23.

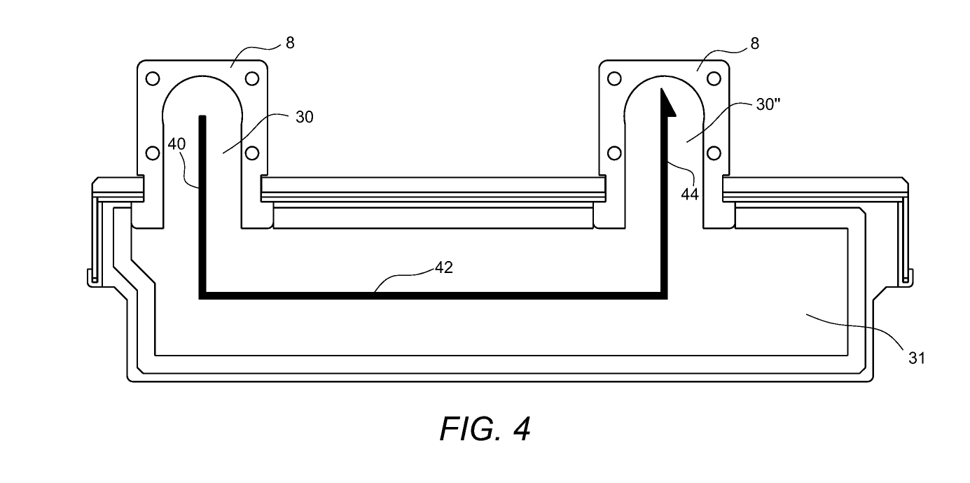

Still referring to FIG. 3, liquid coolant can be circulated through the cooling jacket unit 2 by entering through inlet chamber 32, generally along path 40, into inlet connection nozzles 8, then through passageways 30 and 30′ into the pouches 31, 31′, generally flowing along pathway 42, then exiting passageways 30″, 30′″ into outlet connection nozzle 8, and then into outlet chamber 34, generally flowing along pathway 44. FIG. 4 is a cross-sectional side view of the cooling jacket unit 2 (showing one side of the cooling jacket unit 2 involving one of the pair of pouches 31) of FIG. 3, generally showing the liquid flow path 40-42-44.

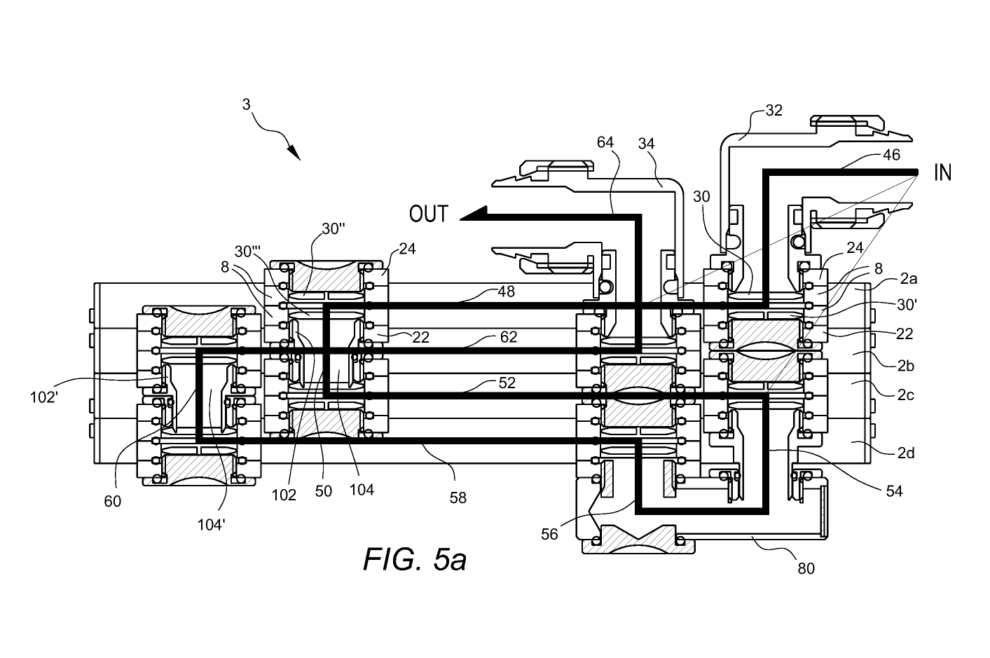

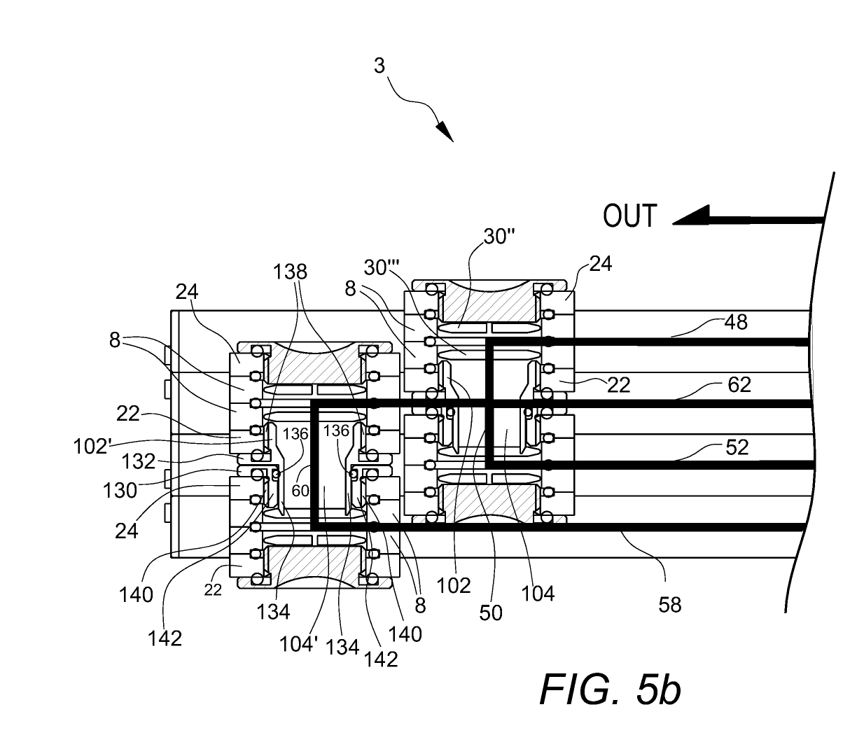

As can be seen in FIG. 5a, a plurality of cooling jacket units 2a, 2b, 2c and 2d can be positioned in proximity to one another with minimal spatial interference between the cooling jacket units to form a cooling jacket assembly 3 for cooling multiple heat generating devices, such as, for example, a plurality of PCBs (not illustrated) mounted on a slot connector connected to a motherboard, with the PCBs being proximate one another in confined spatial orientation. The spatial efficiency of the cooling assembly 3 is achievable, in part, because of the off-centered position of the space between left side and right side connection nozzles 8 on each cooling jacket unit, which allows the connection nozzles 8, and hence the threaded connection plates 22, 24, to be staggered by placing the cooling jacket units 2 together in alternating configuration as shown. For example, unit 2a is oriented so that the threaded connection plates 22, 24 are right-biased in position (i.e., positioned to the right side of the nearest threaded compression plate 22, 24 of another cooling jacket unit 2b). Cooling jacket unit 2b is identical (or substantially identical) to unit 2a, but is flipped in overhead plan view relation to unit 2a, so that the threaded compression plates 22, 24 are left-biased (i.e., positioned to the left side of the nearest threaded compression plates 22, 24 of the adjacent units 2a and 2c). As will be appreciated by those skilled in the art after reviewing this disclosure, this staggered configuration can be repeated as many times as desired, and can be achievable as a result of the off-centered design for the connection nozzles 8 of each cooling jacket unit 2.

When the cooling jacket units 2 are placed together in closely staggered position as shown in the assembly 3 of FIG. 5a, fittings having screw type connector portions can be used to threadedly connect the threaded compression plates 22, 24. For example, in FIG. 5a, the left side connection nozzles 8 of cooling jacket unit 2a are fluidly connected to the left side connection nozzles 8 of cooling jacket unit 2c via a screw-type connector 102 (having an internal fluid flow conduit 104) that is threadedly connected to a threaded compression plate of each cooling jacket unit 2a, 2c. Similarly, the left side connection nozzles 8 of cooling jacket unit 2b are connected to the left side connection nozzles 8 of cooling jacket unit 2d via screw-type connector 102′ (also having an internal fluid flow conduit 104′). Also, a turnaround conduit 80 is provided that is threadedly connected to a threaded compression plate on each of the right side connection nozzles of cooling jacket units 2c and 2d. Finally, an inlet chamber 32 is connected to the right side connection nozzle of cooling jacket unit 2a, and an outlet chamber 34 is connected to the left side connection nozzle of cooling jacket unit 2b.

As such, cooling liquid can flow into the cooling jacket unit 2a through inlet chamber 32, generally along path 46, then through the pouches 31, 31′ in cooling jacket unit 2a generally along path 48, exiting cooling jacket unit 2a and flowing through screw-type connector 102 generally along path 50, into cooling jacket unit 2c, through cooling jacket unit 2c generally along path 52, then turning around in turnaround conduit 80 generally along path 56, and into cooling jacket unit 2d, flowing generally along path 58 before exiting through screw-type connector 102′ and entering cooling jacket unit 2b, then flowing generally along path 62 before exiting assembly 3 through outlet chamber 34, generally along path 64. In this manner, liquid coolant can be circulated (e.g., pumped) through the pouches 31, 31′ of each cooling jacket unit in the assembly 3, to cool the heat generating components or devices to which the cooling jacket units 2a, 2b, 2c, 2d are attached.

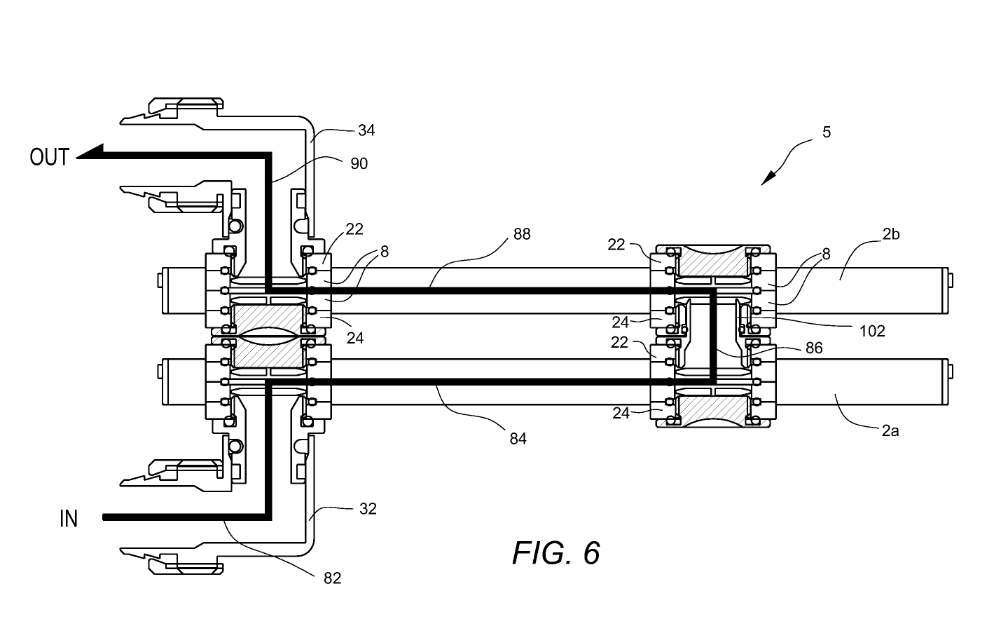

Now, turning to FIG. 6, an alternate embodiment of a cooling jacket assembly 5 is shown. In cooling jacket assembly 5, the cooling jacket units 2a and 2b are not staggered. In contrast with cooling assembly 3 of FIG. 5a, each cooling jacket unit is fluidly connected directly to the immediately adjacent unit, with no cooling jacket unit positioned therebetween. As illustrated in FIG. 6, a screw-type connector 102 threadedly connects one of the right side threaded compression plates 22, 24 of each of the cooling jacket units 2a, 2b, to the right side threaded compression plate of the other cooling jacket unit. Liquid can then flow generally along the path illustrated by the elongated arrow with lines 82-84-86-88-90. As will be appreciated by those skilled in the art after reviewing this disclosure, this configuration can be repeated to add any number of cooling jacket units to the assembly 5. That is, for example, at left side connection nozzle 8 on cooling jacket unit 2b, a screw-type connector 102 could be utilized to fluidly connect threaded compression plate 22 to a threaded compression plate 24 on another cooling jacket unit (not illustrated), and so on, and so forth. The screw-type connectors 102 discussed herein can all be removable and thus provide for versatile flexibility in connecting cooling jacket units in a variety of different assemblies having different configurations. In the configuration shown by cooling assembly 5, the general path of liquid coolant flow is in alternating directions through each cooling jacket unit, until exiting the entire cooling assembly 5.

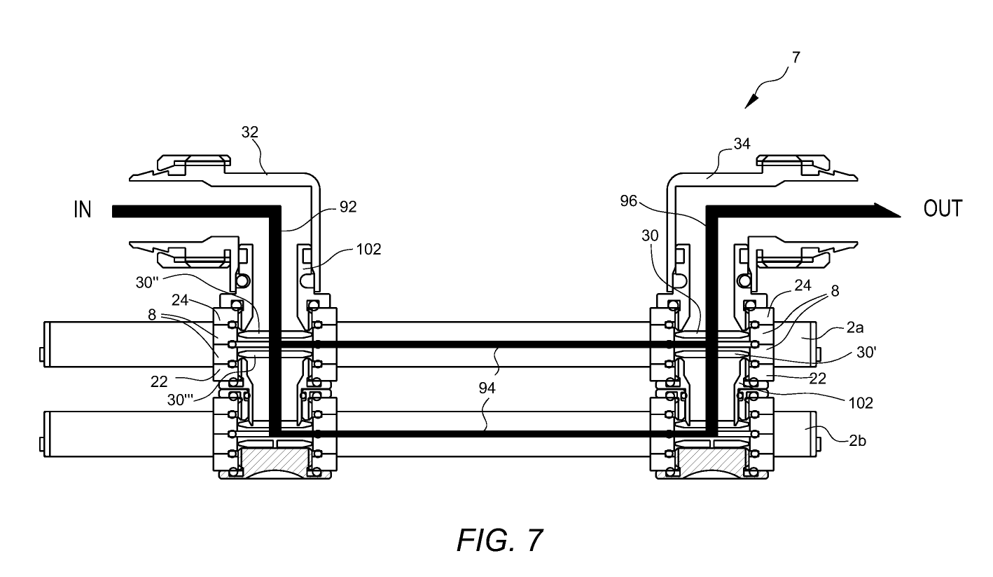

Cooling assemblies 3 and 5 both involve coolant flowing in series through the cooing jacket units. In other embodiments of the present invention, the cooling jacket units can be arranged such that some coolant flow occurs in parallel, or in a combination of parallel and series flow. For example, in FIG. 7, cooling assembly 7 comprises a plurality of cooling jacket units 2a, 2b, wherein fluid is pumped in through inlet chamber 32, generally along path 92, with the coolant flow then diverging to flow through cooling jacket units 2a and 2b in two parallel streams 94, which flow through the cooling jacket units 2a, 2b in parallel, then rejoin at stream portion 96 to exit the cooling assembly 7 through outlet chamber 96. Again, as will be appreciated by those skilled in the art after reviewing this disclosure, any number of cooling jacket units can be arranged in the configuration shown in FIG. 7, to extend the number of cooling jacket units attached in the cooling jacket unit assembly 7. As will be appreciated by those skilled in the art after reviewing this disclosure, fittings can be provided to equalize pressure drop through parallel cooling jacket units to help ensure even flow through the units.

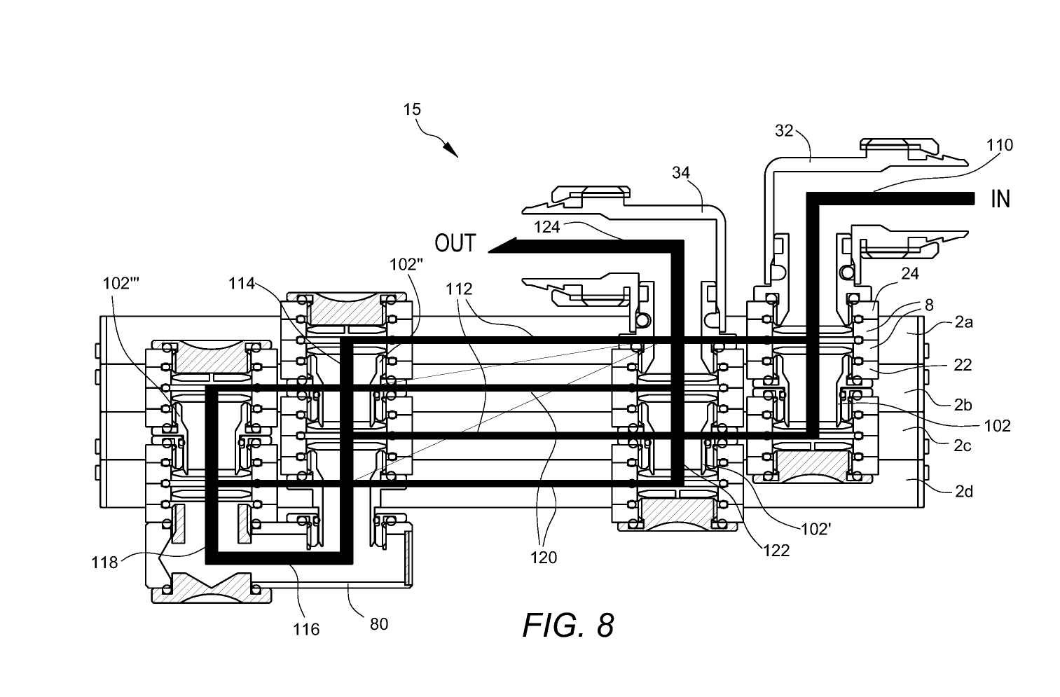

Alternatively, cooling jacket units of the present invention can be arranged in a combination of parallel and series flow configurations. For example, in cooling jacket assembly 15 of FIG. 8, liquid coolant flows along path 110, then diverges into two parallel streams 112 through cooling jacket units 2a and 2c, the parallel streams 112 re-joining at stream 114 after exiting the cooling jacket units 2a, 2c, then flows into turnaround conduit 80 along path 116, and into cooling jacket units 2b and 2d along path 118 before diverging into two parallel streams 120 inside those cooling jacket units 2b & 2d, then once again re-joining as stream 122 before exiting outlet chamber 34 as stream 124.

Now referring to FIG. 5b, in some embodiments of the present invention, the screw-type connector 102′ comprises a male portion 134 and female portion 142. The male portion 134 has a threaded member 138 capable of being threadedly connected to the threaded compression plate 22, and the female portion 142 has threaded member 140 capable of being threadedly connected to the threaded compression plate 24. The female portion 142 also includes an annular O-ring seal 136. The male portion 134 can be concentrically inserted in the female portion 142, as shown in FIG. 5b, with the O-ring seal 136 abutting against an outside wall of the male portion 134 to effectuate a seal so that coolant can flow through the fluid flow conduit 104′. As shown in FIGS. 5b, 9 and 10, the male portion 134 has a circular grip plate 132 with a grated edge 132′, which can be used to manually grip and turn the male portion 134 to threadedly connect it to the corresponding threaded compression plate 22, and the female portion 142 also has a circular grip plate 130, having a grated edge 130′, which can be used to manually grip and turn the female portion 142 to threadedly connect it to the corresponding threaded compression plate 24.

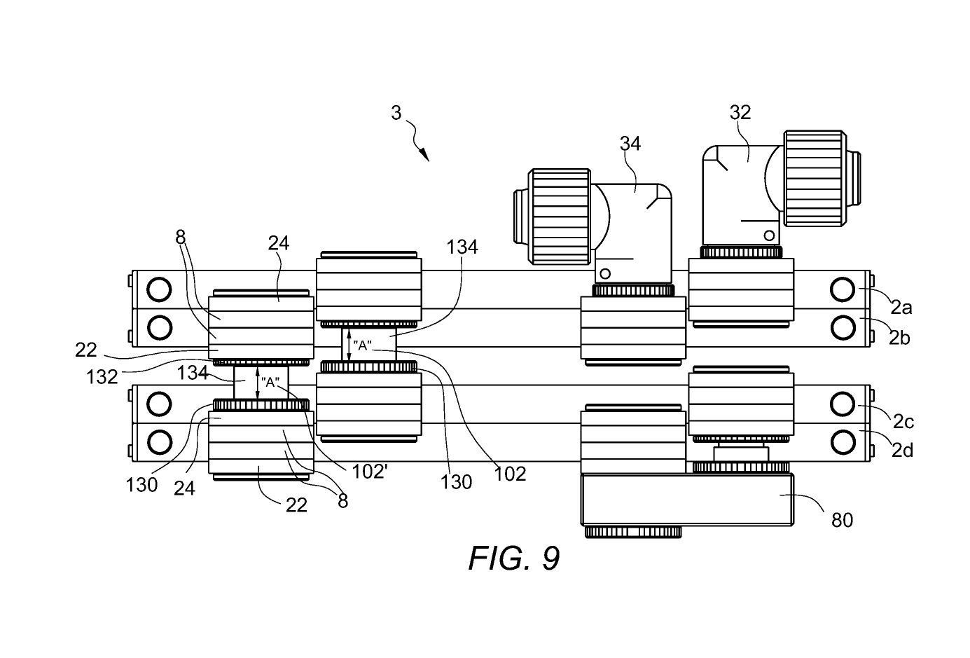

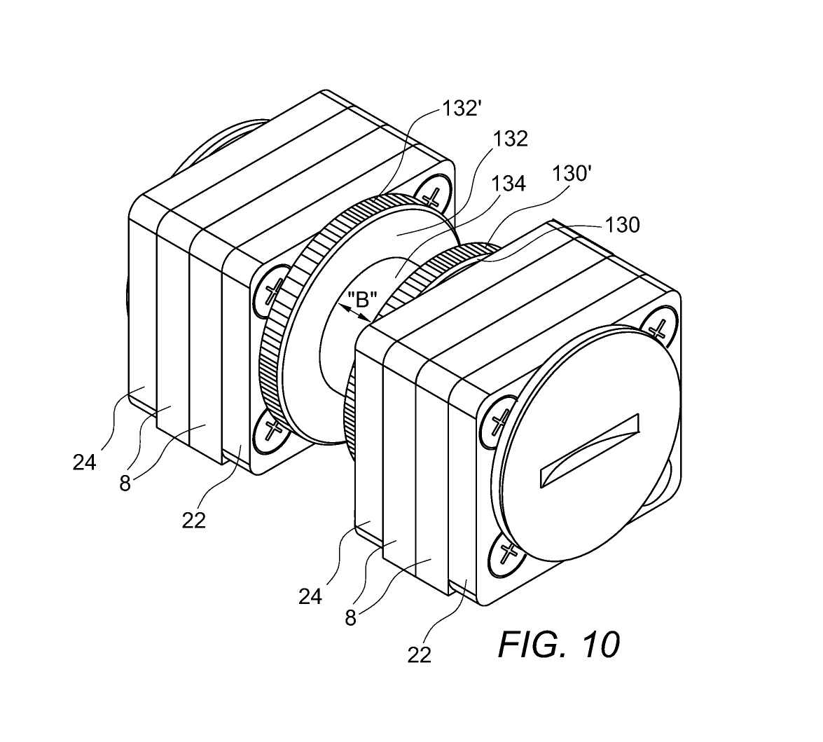

Referring now to FIGS. 9 and 10 only, arrows “A” and “B” illustrate directions in which the male portion 134 can slide to extend or retract the male portion 134 within the female portion 142, to achieve desired spacing between the cooling jacket units 2a, 2b, 2c, 2d. As will be appreciated by those skilled in the art after reviewing this disclosure, depending on the specific cooling jacket assembly configuration utilized, the flexibility provided by sliding the male portion 134 in the directions of arrows “A” and “B” can, among other things, permit a cooling jacket assembly of the present invention to conform to different spacing between heat generating elements, such as PCBs on a slotted connector. That is, the PCBs may be spaced apart on the slotted connected, rather than, for example, in adjacent slots, and the sliding feature of the screw-type connector 102′ can provide flexibility to adapt the cooling jacket assemblies of the present invention to the spaced-apart or adjacent PCBs.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A cooling unit comprising:
an inlet connection nozzle;
an outlet connection nozzle; and
a deformable pouch connected to the inlet connection nozzle and the outlet connection nozzle, wherein a space between the inlet connection nozzle and the outlet connection nozzle is off-centered with respect to a longitudinal axis of the deformable pouch.

2. The cooling unit of claim 1 further comprising a case for covering the pouch and bracing the pouch against a heat generating device, the case having a first opening for the inlet connection nozzle and a second opening for the outlet connection nozzle, wherein a space between the first opening and second opening is off-centered with respect to a longitudinal axis of the case.

3. The cooling unit of claim 1 further comprising a threaded member connected to the outlet connection nozzle and a threaded member connected to the inlet connection nozzle, the threaded members having threaded openings configured to receive a removable connector for fluidly connecting the cooling unit to another cooling unit.

4. The cooling unit of claim 3 wherein the threaded members are plates having circular openings that are alignable with circular openings of the connection nozzles.

5. The cooling unit of claim 1 wherein each of the inlet connection nozzle and outlet connection nozzle have at least one fluid flow passageway that opens on a sidewall of a circular opening.

6. The cooling unit of claim 5 wherein the inlet connection nozzle and the outlet connection nozzle can each be coupled to a threaded plate having a threaded opening that is alignable with the circular opening of the respective connection nozzle to accommodate fluid flow through the threaded plates into the fluid flow passageways of the connection nozzles.

7. The cooling unit of claim 6 further comprising a second deformable pouch, wherein the deformable pouches are disposed in side-by-side relation within a case, and wherein a heat generation element can be disposed between the deformable pouches.

8. A cooling assembly comprising:
a plurality of cooling units, each cooling unit comprising:
at least one inlet connection nozzle;
at least one outlet connection nozzle;
at least one deformable pouch connected to the at least one inlet connection nozzle and the at least one outlet connection nozzle; and
a case enclosing the at least one deformable pouch;
and wherein the plurality of cooling units are fluidly connected to one another by removable conduits, with each case of each cooling unit being adjacent to at least one case of another cooling unit, and wherein the connection nozzles of each cooling unit are disposed in staggered orientation with respect to each adjacent cooling unit.

9. The cooling assembly of claim 8 wherein fluid can flow from a deformable pouch of a first cooling unit to a deformable pouch of a non-adjacent cooling unit through a removable conduit, with an adjacent unit between disposed between the first cooling unit and the non-adjacent unit.

10. The cooling assembly of claim 8 wherein fluid can flow to the adjacent unit after flowing through the non-adjacent unit.

11. The cooling assembly of claim 8 wherein fluid can flow from an inlet chamber and diverge into two separate fluid flow streams which can flow through at least two deformable pouches of two cooling units in parallel fashion.

12. The cooling assembly of claim 11 wherein the two cooling units are two non-adjacent cooling units, and wherein an adjacent cooling unit is disposed between the two non-adjacent cooling units.

13. The cooling assembly of claim 12 wherein fluid flows through the adjacent unit after flowing through the two non-adjacent cooling units.

14. A cooling assembly comprising:
a plurality of cooling units, each cooling unit having a plurality of internal cooling pouches, the pouches being deformable to conform to a surface of a heating generating element, wherein each of the plurality of cooling units is disposed in close proximity to another cooling unit and is fluidly connected to another cooling unit; and
a plurality of removable connectors for use in fluidly connecting the plurality of cooling units in a plurality of different flow configurations, wherein each of the cooling units has an inlet connection nozzle and an outlet connection nozzle with each connection nozzle being in fluid communication with at least one internal cooling pouch and with each connection nozzle being coupled to a connector member for using in coupling the connection nozzles to the removable connectors, and wherein the connector members of each of the cooling units can be positioned in staggered or non-staggered relation to the connector members of adjacent cooling units, and wherein the removable connectors can be used to fluidly connect the plurality of cooling units together regardless of whether the connector members are positioned in staggered or non-staggered relation.

15. The cooling assembly of claim 14 wherein the connector members are plate-like members with each member having a threaded circular opening to which the removable connectors can be coupled.

16. The cooling assembly of claim 14 wherein the connection nozzles are plate-like members with each having a circular opening with a fluid flow passageway formed on a sidewall of the circular opening.

17. The cooling assembly of claim 16 wherein a plane of the plate-like connection nozzles is substantially parallel to a plane of the corresponding pouch connected to the connection nozzles.

18. The cooling assembly of claim 17 wherein the connector members are plate-like members with each connector member having a threaded circular opening to which the removable connectors can be coupled, and wherein the plate-like connector members are fixedly coupled to the plate-like connection nozzles in parallel orientation with respect to one another.

19. The cooling assembly of claim 14 wherein coolant can be circulated simultaneously through more than one of the cooling units of the cooling assembly in parallel flow configuration.

20. The cooling assembly of claim 14 wherein coolant can be circulated through the cooling units in the cooling assembly in series flow configuration.

21. A cooling assembly comprising:
a plurality of cooling units disposed in proximity to one another and attached to one another; and
a plurality of removable connectors for use in fluidly connecting the plurality of cooling units in a plurality of different flow configurations, wherein at least some of the removable connectors comprise a male connector portion and a female connector portion, with the male connector portion being slidably adjustable with respect to the female connector portion.

22. The cooling assembly of claim 21 wherein each of the cooling units has an inlet connection nozzle and an outlet connection nozzle with each connection nozzle being in fluid communication with at least one internal cooling pouch and with each connection nozzle being coupled to a connector member for using in coupling the connection nozzles to the removable connectors, and wherein the connector members of each of the cooling units can be positioned in staggered or non-staggered relation to the connector members of adjacent cooling units, and wherein the removable connectors can be used to fluidly connect the plurality of cooling units together regardless of whether the connector members are positioned in staggered or non-staggered relation.

23. The cooling assembly of claim 22 wherein the connector members are plate-like members with each connector member having a threaded circular opening to which the removable connectors can be coupled.

24. The cooling assembly of claim 22 wherein the connection nozzles are plate-like members with each connection nozzle having a circular opening with a fluid flow passageway formed on a sidewall of the circular opening.
